(19) United States
(12) Patent Application Publication
(10) Pub. No.: US 2024/0208149 A1
(43) Pub. Date: Jun. 27, 2024

(54) MANUFACTURING METHOD OF THREE-DIMENSIONAL OBJECT AND INFORMATION PROCESSING APPARATUS

(71) Applicant: SEIKO EPSON CORPORATION, Tokyo (JP)

(72) Inventors: Satoshi YAMAZAKI, MATSUMOTO-SHI (JP); Eiji OKAMOTO, MATSUMOTO-SHI (JP)

(21) Appl. No.: 18/390,069

(22) Filed: Dec. 20, 2023

(30) Foreign Application Priority Data
Dec. 23, 2022 (JP) 2022-206645

(51) Int. Cl. B29C 64/386

(52) U.S. Cl. CPC B29C 64/386; B33Y 10/00

(57) ABSTRACT

Provided is a manufacturing method of a three-dimensional object for manufacturing the three-dimensional object by extruding a modeling material from an extruding unit toward a stage and depositing layers, the manufacturing method including: acquiring designation information including at least one of information for designating a center-of-gravity position of the three-dimensional object and information for designating a weight of the three-dimensional object; generating model data including information on a path of the extruding unit with respect to the stage and information on an extruding amount of the modeling material in the path based on the designation information; and controlling the extruding unit based on the model data and fabricating the three-dimensional object.

The present application is based on, and claims priority from JP Application Serial Number 2022-206645, filed Dec. 23, 2022, the disclosure of which is hereby incorporated by reference herein in its entirety.

### BACKGROUND

### 1. Technical Field

The present disclosure relates to a manufacturing method of a three-dimensional object and an information processing apparatus.

### 2. Related Art

A method for manufacturing a three-dimensional object by extruding a plasticized material toward a stage and curing the plasticized material is known.

For example, JP-A-2017-7127 discloses a method of calculating a center of gravity of a three-dimensional model of a target object that is a fabrication target, and determining an arrangement of a support that supports the three-dimensional model based on the calculated center of gravity.

In the target object as described above, it is required to set a position of the center of gravity and the weight to be desired ones to improve convenience of a user.

### SUMMARY

One aspect of a manufacturing method of a three-dimensional object according to the present disclosure is a manufacturing method of a three-dimensional object for manufacturing the three-dimensional object by extruding a modeling material from an extruding unit toward a stage and depositing layers, the manufacturing method including:
acquiring designation information including at least one of information for designating a center-of-gravity position of the three-dimensional object and information for designating a weight of the three-dimensional object;
generating model data including information on a path of the extruding unit with respect to the stage and information on an extruding amount of the modeling material in the path based on the designation information; and
controlling the extruding unit based on the model data and fabricating the three-dimensional object.

One aspect of an information processing apparatus according to the present disclosure is an information processing apparatus for generating model data for manufacturing a three-dimensional object by extruding a modeling material from an extruding unit toward a stage and depositing layers, the information processing apparatus including:
an acquisition unit configured to acquire designation information including at least one of information for designating a center-of-gravity position of the three-dimensional object and information for designating a weight of the three-dimensional object; and
a data generation unit configured to generate the model data including information on a path of the extruding unit with respect to the stage and information on an extruding amount of the modeling material in the path based on the designation information.

### BRIEF DESCRIPTION OF THE DRAWINGS

FIG. 1 is a cross-sectional view schematically showing a three-dimensional fabrication system according to an embodiment.

FIG. 2 is a perspective view schematically showing a flat screw of a three-dimensional fabrication device according to the embodiment.

FIG. 3 is a plan view schematically showing a barrel of the three-dimensional fabrication device according to the embodiment.

FIG. 4 is a flowchart showing processing of an information processing apparatus according to the embodiment.

FIG. 5 is a perspective view schematically showing a model of a three-dimensional object.

FIG. 6 is a plan view schematically showing the model of the three-dimensional object.

FIG. 7 is a cross-sectional view schematically showing the model of the three-dimensional object.

FIG. 8 is a diagram showing model data.

FIG. 9 is a flowchart showing processing of a control unit of the three-dimensional fabrication device according to the embodiment.

FIG. 10 is a cross-sectional view showing the processing of the control unit of the three-dimensional fabrication device according to the embodiment.

FIG. 11 is a flowchart showing a modification of the processing of the information processing apparatus according to the embodiment.

FIG. 12 is a side view schematically showing a model of the three-dimensional object.

FIG. 13 is a side view schematically showing a model of the three-dimensional object.

FIG. 14 is a side view schematically showing a model of the three-dimensional object.

### DESCRIPTION OF EMBODIMENTS

Hereinafter, a preferred embodiment of the present disclosure will be described in detail with reference to the drawings. The embodiment described below does not unduly limit contents of the present disclosure disclosed in the claims. Further, all configurations to be described below are not necessary elements of the present disclosure.

### 1. Three-Dimensional Fabrication System

### 1.1. Overall Configuration

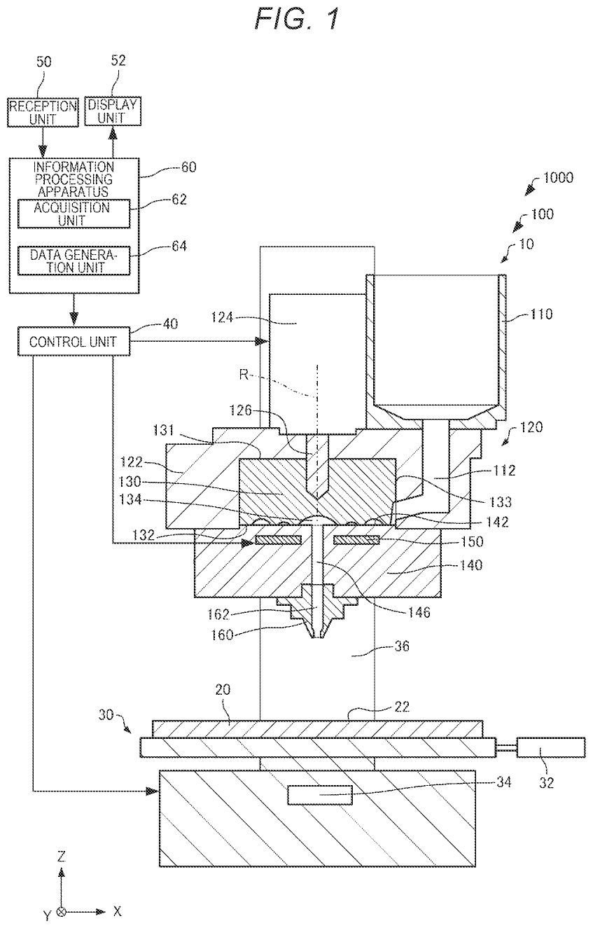

First, a three-dimensional fabrication system according to the embodiment will be described with reference to the drawings. FIG. 1 is a cross-sectional view schematically showing a three-dimensional fabrication system 1000 according to the embodiment. FIG. 1 shows an X axis, a Y axis, and a Z axis as three axes orthogonal to one another. An X-axis direction and a Y-axis direction are, for example, horizontal directions. A Z-axis direction is, for example, a vertical direction.

As shown in FIG. 1, the three-dimensional fabrication system 1000 includes a three-dimensional fabrication device 100, a reception unit 50, a display unit 52, and an information processing apparatus 60. As shown in FIG. 1, the three-dimensional fabrication device 100 includes, for example, an extruding unit 10, a stage 20, a movement unit 30, and a control unit 40.

The three-dimensional fabrication device 100 drives the movement unit 30 to change a relative position between the extruding unit 10 and the stage 20 while extruding a plasticized modeling material from the extruding unit 10 toward the stage 20. Accordingly, the three-dimensional fabrication device 100 fabricates a three-dimensional object having a desired shape at the stage 20. The three-dimensional fabrication device 100 is a fused deposition modeling (FDM) (registered trademark) three-dimensional fabrication device.

Although not illustrated, a plurality of extruding units 10 may be provided. For example, two extruding units 10 may be provided. In this case, both of the two extruding units 10 may extrude the modeling material constituting the three-dimensional object, and one may extrude the modeling material, and the other may extrude a support material that supports the three-dimensional object. The two extruding units 10 may be arranged in the X-axis direction.

The extruding unit 10 includes, for example, a material storing unit 110, a plasticization unit 120, and a nozzle 160.

The material storing unit 110 stores a pellet-shaped or powder-shaped material. The material storing unit 110 supplies the material to the plasticization unit 120. The material storing unit 110 includes, for example, a hopper. The material housed in the material storing unit 110 is, for example, an acrylonitrile butadiene styrene (ABS) resin.

The material storing unit 110 and the plasticization unit 120 are coupled by a supply path 112 provided below the material storing unit 110. The material put into the material storing unit 110 is supplied to the plasticization unit 120 via the supply path 112.

The plasticization unit 120 includes, for example, a screw case 122, a drive motor 124, a flat screw 130, a barrel 140, and a heater 150. The plasticization unit 120 plasticizes at least a part of the material in a solid state supplied from the material storing unit 110, generates a paste-shaped modeling material having fluidity, and supplies the generated modeling material to the nozzle 160.

The term plasticization refers to a concept including melting, and refers to changing a material from a solid state to a state having fluidity. Specifically, in a case of a material in which glass transition occurs, the term plasticization refers to setting a temperature of the material to be equal to or higher than a glass transition point. In a case of a material in which the glass transition does not occur, the term plasticization refers to setting the temperature of the material to be equal to or higher than a melting point.

The screw case 122 is a housing that houses the flat screw 130. The barrel 140 is provided at a lower surface of the screw case 122. The flat screw 130 is housed in a space surrounded by the screw case 122 and the barrel 140.

The drive motor 124 is provided at an upper surface of the screw case 122. The drive motor 124 is, for example, a servomotor. A shaft 126 of the drive motor 124 is coupled to an upper surface 131 of the flat screw 130. The drive motor 124 is controlled by the control unit 40. Although not illustrated, the shaft 126 of the drive motor 124 and the upper surface 131 of the flat screw 130 may be coupled to each other via a speed reducer.

The flat screw 130 has a substantially columnar shape whose size in a direction of a rotation axis R is smaller than a size in a direction orthogonal to the direction of the rotation axis R. In the illustrated example, the rotation axis R is parallel to the Z axis. The flat screw 130 is rotated about the rotation axis R by a torque generated by the drive motor 124.

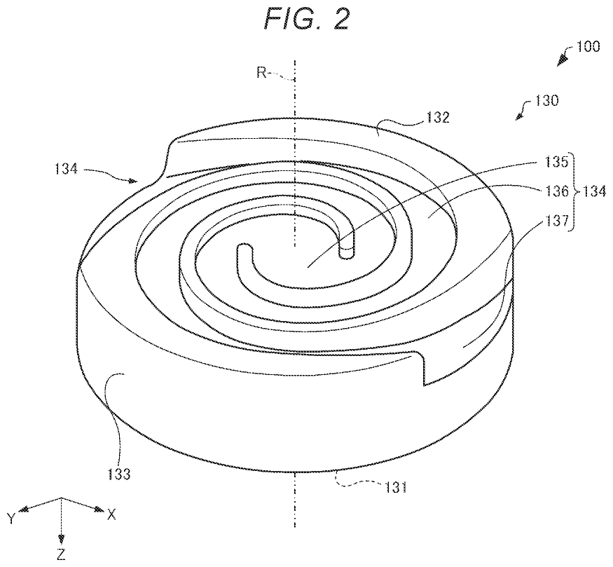

The flat screw 130 has the upper surface 131, a groove forming surface 132 on an opposite side from the upper surface 131, and a side surface 133 that couples the upper surface 131 to the groove forming surface 132. A first groove 134 is formed in the groove forming surface 132. The side surface 133 is, for example, perpendicular to the groove forming surface 132. Here, FIG. 2 is a perspective view schematically showing the flat screw 130. For convenience, FIG. 2 shows a state where an upper-lower positional relationship is reversed from a state shown in FIG. 1.

As shown in FIG. 2, the first groove 134 is formed in the groove forming surface 132 of the flat screw 130. The first groove 134 includes, for example, a central portion 135, a coupling portion 136, and a material introduction portion 137. The central portion 135 faces a communication hole 146 formed in the barrel 140. The central portion 135 communicates with the communication hole 146. The coupling portion 136 couples the central portion 135 to the material introduction portion 137. In the illustrated example, the coupling portion 136 is spirally provided from the central portion 135 toward an outer periphery of the groove forming surface 132. The material introduction portion 137 is provided at the outer periphery of the groove forming surface 132. That is, the material introduction portion 137 is provided in the side surface 133 of the flat screw 130. The material supplied from the material storing unit 110 is introduced from the material introduction portion 137 into the first groove 134, and is transported to the communication hole 146 formed in the barrel 140 through the coupling portion 136 and the central portion 135. For example, two first grooves 134 are provided.

The number of the first grooves 134 is not particularly limited. Although not illustrated, three or more first grooves 134 may be provided, or only one first groove 134 may be provided.

Although not illustrated, the plasticization unit 120 may include a long in-line screw having a spiral groove in a side surface, instead of the flat screw 130. The plasticization unit 120 may plasticize the material by rotation of the in-line screw.

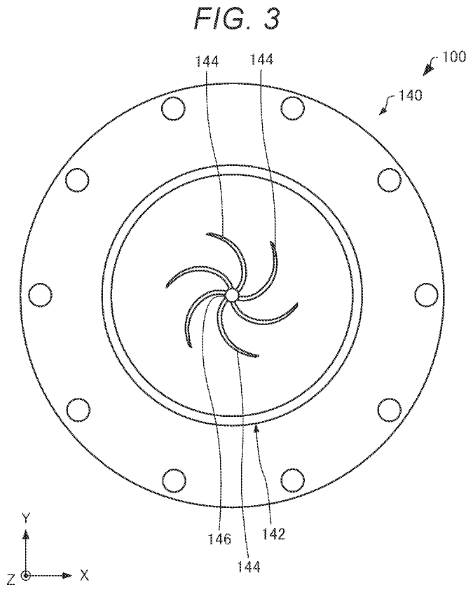

As shown in FIG. 1, the barrel 140 is provided below the flat screw 130. The barrel 140 has a facing surface 142 facing the groove forming surface 132 of the flat screw 130. The communication hole 146 that communicates with the first groove 134 is formed at a center of the facing surface 142. Here, FIG. 3 is a plan view schematically showing the barrel 140.

As shown in FIG. 3, second grooves 144 and the communication hole 146 are formed in the facing surface 142 of the barrel 140. A plurality of second grooves 144 are formed. In the illustrated example, although six second grooves 144 are formed, the number of the second grooves 144 is not particularly limited. The plurality of second grooves 144 are formed around the communication hole 146 when viewed from the Z-axis direction. One end of the second groove 144 is coupled to the communication hole 146, and the second groove 144 spirally extends from the communication hole 146 toward an outer periphery of the barrel 140. The second groove 144 has a function of guiding the plasticized modeling material to the communication hole 146.

A shape of the second groove 144 is not particularly limited, and may be, for example, linear. Further, one end of the second groove 144 may not be coupled to the communication hole 146. Furthermore, the second grooves 144 may not be formed in the facing surface 142. However, in consideration of efficiently guiding the plasticized material to the communication hole 146, the second grooves 144 are preferably formed in the facing surface 142.

As shown in FIG. 1, the heater 150 is provided in the barrel 140. The heater 150 heats the material supplied between the flat screw 130 and the barrel 140. An output of the heater 150 is controlled by the control unit 40. The plasticization unit 120 heats the material while transporting the material toward the communication hole 146 to generate the plasticized modeling material by the flat screw 130, the barrel 140, and the heater 150. The plasticization unit 120 causes the generated modeling material to flow out from the communication hole 146.

When viewed from the Z-axis direction, the heater 150 may have a ring shape. Further, the heater 150 may be provided below the barrel 140 instead of being in the barrel 140.

The nozzle 160 is provided below the barrel 140. A nozzle flow path 162 is formed in the nozzle 160. The nozzle flow path 162 communicates with the communication hole 146. The modeling material is supplied from the communication hole 146 to the nozzle flow path 162. The nozzle 160 extrudes the modeling material supplied to the nozzle flow path 162 toward the stage 20.

The stage 20 is provided below the nozzle 160. In the illustrated example, the stage 20 has a rectangular parallelepiped shape. The stage 20 has a deposition surface 22 on which the modeling material is deposited. The deposition surface 22 is a region on an upper surface of the stage 20.

A material of the stage 20 is, for example, a metal such as aluminum. The stage 20 may include a metal plate and an adhesion sheet provided at the metal plate. In this case, the deposition surface 22 is formed of the adhesion sheet. The adhesion sheet can improve adhesiveness between the stage 20 and the modeling material extruded from the extruding unit 10.

Although not illustrated, the stage 20 May include a metal plate where a groove is formed and an underlayer that fills the groove. In this case, the deposition surface 22 is formed of the underlayer. A material of the underlayer is, for example, the same as the modeling material. The underlayer can improve adhesiveness between the stage 20 and the modeling material extruded from the extruding unit 10.

The movement unit 30 supports the stage 20. The movement unit 30 changes the relative position between the extruding unit 10 and the stage 20. In the illustrated example, the movement unit 30 moves the stage 20 in the X-axis direction and the Y-axis direction, thereby changing the relative position between the nozzle 160 and the stage 20 in the X-axis direction and the Y-axis direction. Further, the movement unit 30 moves the extruding unit 10 in the Z-axis direction, thereby changing the relative position between the nozzle 160 and the stage 20 in the Z-axis direction.

The movement unit 30 includes, for example, a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the extruding unit 10 in the Z-axis direction.

As long as the movement unit 30 can change the relative position between the extruding unit 10 and the stage 20, the configuration of the movement unit 30 is not particularly limited. The movement unit 30 may, for example, move the stage 20 in the Z-axis direction and move the extruding unit 10 in the X-axis direction and the Y-axis direction. Alternatively, the movement unit 30 may move the stage 20 or the extruding unit 10 in the X-axis direction, the Y-axis direction, and the Z-axis direction.

The control unit 40 includes, for example, a computer including a processor, a main storage device, and an input and output interface that inputs and outputs a signal from and to outside. The control unit 40 implements various functions by, for example, executing a program read into the main storage device by the processor. Specifically, the control unit 40 controls the extruding unit 10 and the movement unit 30. The control unit 40 may include a combination of a plurality of circuits instead of the computer.

The reception unit 50 receives an instruction from a user. The reception unit 50 transmits a signal to the information processing apparatus 60 according to the received instruction from the user. The reception unit 50 includes, for example, a mouse, a keyboard, a touch panel, and a microphone.

The display unit 52 displays various images according to an instruction from the information processing apparatus 60. The display unit 52 includes, for example, a liquid crystal display (LCD), an organic electroluminescence (EL) display, an electrophoretic display (EPD), or a touch panel display.

The information processing apparatus 60 implements various functions by, for example, executing a program read into the main storage device by the processor. The information processing apparatus 60 extrudes the modeling material from the extruding unit 10 toward the stage 20 and deposits layers, and generates model data for manufacturing a three-dimensional object. The information processing apparatus 60 includes an acquisition unit 62 that acquires designation information including at least one of information for designating a center-of-gravity position of the three-dimensional object and information for designating a weight of the three-dimensional object, and a data generation unit 64 that generates model data including information on a path of the extruding unit 10 with respect to the stage 20 and an extruding amount of the modeling material in the path based on the designation information. The information processing apparatus 60 includes, for example, a central processing unit (CPU), a micro processing unit (MPU), a digital signal processor (DSP), and an application specific integrated circuit (ASIC). Although not illustrated, the control unit 40 and the information processing apparatus 60 may be integrally provided as one device.

### 1.2. Processing of Information Processing Apparatus

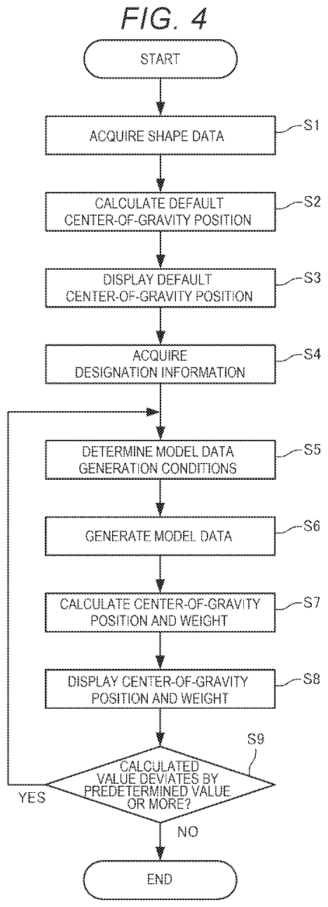

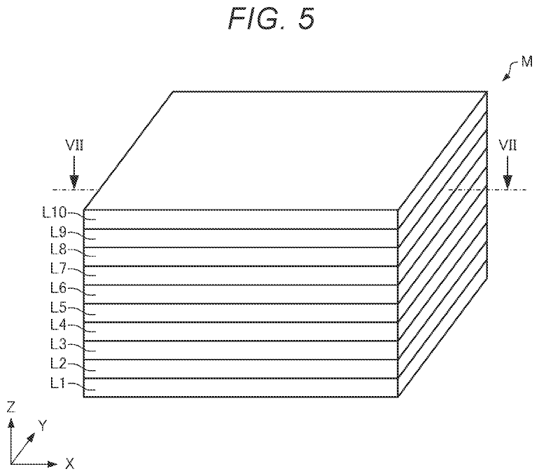

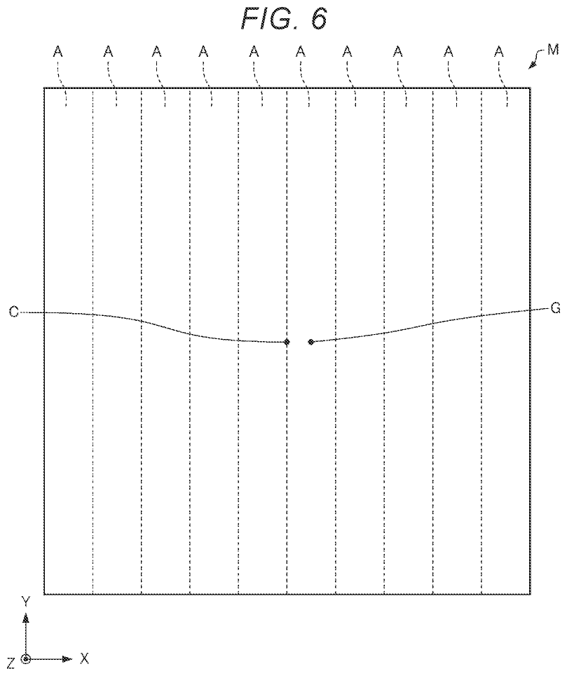

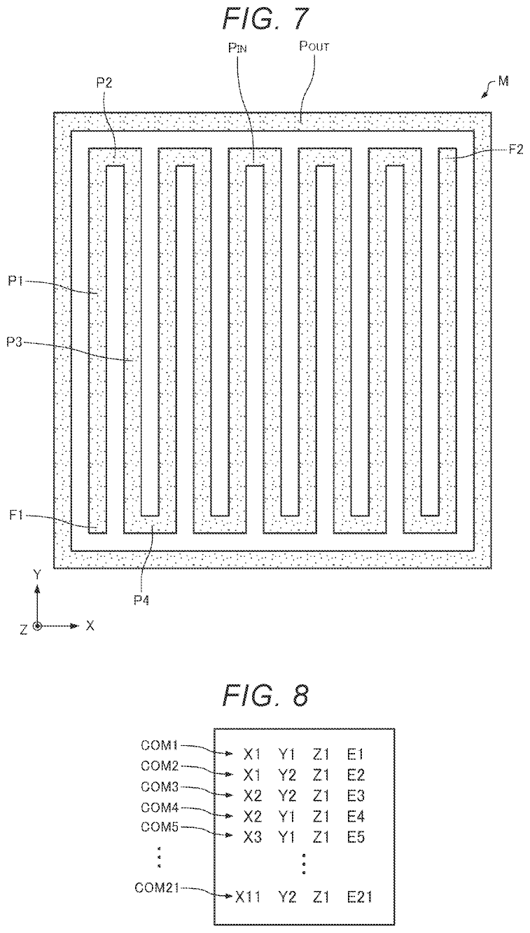

Next, processing of the information processing apparatus 60 according to the embodiment will be described with reference to the drawings. FIG. 4 is a flowchart showing the processing of the information processing apparatus 60. FIG. 5 is a perspective view schematically showing a model M of the three-dimensional object manufactured by the three-dimensional fabrication device 100. FIG. 6 is a plan view schematically showing the model M. FIG. 7 is a cross-sectional view schematically showing the model M along a line VII-VII in FIG. 5.

For example, the user operates the reception unit 50, and outputs a processing start signal for starting processing to the information processing apparatus 60. The information processing apparatus 60 starts the processing when receiving the processing start signal.

### 1.2.1. Step S1

As shown in FIG. 4, the information processing apparatus 60 performs processing of acquiring shape data transmitted by the operation of the reception unit 50 performed by the user. The acquisition unit 62 of the information processing apparatus 60 performs the processing in step S1.

The shape data is data representing a target shape of the three-dimensional object created using three-dimensional computer aided design (CAD) software, three-dimensional computer graphics (CG) software, and the like. As the shape data, for example, data in a standard triangulated language (STL) format, or an additive manufacturing file format (AMF) is used.

### 1.2.2. Step S2

Next, the information processing apparatus 60 performs processing of calculating a default center-of-gravity position of the three-dimensional object based on the acquired shape data. The data generation unit 64 of the information processing apparatus 60 performs the processing in step S2 and processing in steps S3 to S9 to be described later.

Specifically, as shown in FIG. 5, the information processing apparatus 60 divides the model M of the three-dimensional object based on the shape data into layers L having a predetermined thickness. In the illustrated example, the model M is divided into ten layers L1 to L10 as the layers L. The information processing apparatus 60 is, for example, slicer software. The information processing apparatus 60 calculates, as the default center-of-gravity position, the center-of-gravity position of the model M when a weight distribution is uniform in an in-plane direction for the divided layers L. The term “in-plane direction” is a direction orthogonal to a thickness direction of the layers L. In the illustrated example, the thickness direction of the layers L is the Z-axis direction. The model M has, for example, a rectangular parallelepiped shape. The shape of the model M and the number of layers L are not particularly limited. The shape of the model M may be columnar. The number of layers L may be designated by the user.

### 1.2.3. Step S3

Next, as shown in FIG. 4, the information processing apparatus 60 performs processing of displaying the calculated default center-of-gravity position on the display unit 52.

### 1.2.4. Step S4

Next, the information processing apparatus 60 performs processing of acquiring the designation information. The designation information includes the information for designating the center-of-gravity position of the three-dimensional object (hereinafter, also referred to as “center-of-gravity position information”) and the information for designating the weight of the three- dimensional object (also referred to as “weight information”). The designation information may include the center-of-gravity position information but not include the weight information, or may include the weight information but not include the center-of-gravity position information.

Specifically, the user operates the reception unit 50 and designates the center-of-gravity position and the weight of the three-dimensional object. The user designates the center-of-gravity position by, for example, inputting coordinates (X, Y, Z). The user designates the weight by, for example, inputting a desired numerical value. The method for designating the center-of-gravity position is not limited to inputting the coordinates, and may be a designation method such as “an upper side of the three-dimensional object” and “a lower side of the three-dimensional object”.

When the center-of-gravity position designated by the center-of-gravity position information and the weight designated by the weight information cannot be compatible, the information processing apparatus 60 may acquire priority information designating which one to prioritize. The priority information is designated by the user.

The designation information may further include information for designating the weight distribution of the three-dimensional object (hereinafter, also referred to as “weight distribution information”).

For example, when the center-of-gravity position is designated as the layer L7 and a weight distribution in the Z-axis direction is designated, the user inputs a weight of the layer L7 as a reference value and weight distributions of the layers L1 to L6 and L8 to L10 as ratios with respect to the reference value. Accordingly, the user can designate the weight distribution in the Z-axis direction.

For example, as shown in FIG. 6, when a center-of-gravity position G is designated in the +X-axis direction with respect to a center position C, and when the weight distribution in the X-axis direction is designated, the user inputs a weight of a predetermined region A including the center-of-gravity position G as a reference and weights of other regions A as ratios with respect to the reference value. Accordingly, the user can designate the weight distribution in the X-axis direction.

In the example shown in FIG. 6, a shape of the region A is rectangular. The number of regions A is ten. A plurality of regions A are arranged in the X-axis direction. The shape, the number, and the arrangement direction of the regions A are not particularly limited. For example, when a plurality of regions are arranged in the Y-axis direction, the user can designate a weight distribution in the Y-axis direction. The shape, the number, and the arrangement direction of the regions A may be designated by the user.

The reception unit 50 receives the designation information including the center-of-gravity position information, the weight information, and the weight distribution information by the method described above. The reception unit 50 transmits the received designation information to the information processing apparatus 60. Accordingly, the information processing apparatus 60 acquires the designation information.

### 1.2.5. Step S5

Next, as shown in FIG. 4, the information processing apparatus 60 performs processing of determining model data generation conditions based on the acquired designation information.

Specifically, the information processing apparatus 60 determines the model data generation conditions such that the center-of-gravity position designated by the center-of-gravity position information, the weight designated by the weight information, and the weight distribution designated by the weight distribution information are achieved.

The model data generation conditions include, for example, a condition of an infill filling rate, a condition of a fill pattern, a condition of a line width, a condition of a depositing pitch, and a condition of a modeling material.

As shown in FIG. 7, the term “infill filling rate” is a filling rate of an internal path P_{IN} surrounded by an outer periphery path P_{OUT} that defines an outer periphery of the model M. When the infill filling rate is 100%, a region surrounded by the outer periphery path P_{OUT} is completely filled with the internal path P_{IN}. When the infill filling rate is 0%, the internal path P_{IN} does not exist in the region surrounded by the outer periphery path P_{OUT}. The outer periphery path P_{OUT} and the internal path P_{IN} correspond to the path of the extruding unit 10 with respect to the stage 20. The outer periphery path P_{OUT} has a continuous shape.

The term “fill pattern” refers to a shape of the internal path P_{IN}. In the illustrated example, the internal path P_{IN} has a shape of extending in the X-axis direction while reciprocating in the Y-axis direction. The shape of the internal path P_{IN} is not particularly limited, and may be, for example, spiral, or may be a plurality of divided polygons or circles.

The term “line width” refers to a width of the internal path P_{IN}. Specifically, the line width is a size in a direction orthogonal to the extending direction of the internal path P_{IN}. In the illustrated example, in a portion of the internal path P_{IN} that extends in the X-axis direction, the line width is a size in the Y-axis direction. In a portion of the internal path P_{IN} that extends in the Y-axis direction, the line width is a size in the X-axis direction.

As shown in FIG. 5, the term “depositing pitch” refers to a pitch of the deposited layers L. Specifically, the depositing pitch is a thickness of the layers L. In the illustrated example, the thicknesses of the deposited layers L are the same as one another.

The information processing apparatus 60 adjusts at least one of the condition of the infill filling rate, the condition of the fill pattern, the condition of the line width, the condition of the depositing pitch, and the condition of the modeling material to determine the model data generation conditions such that the center-of-gravity position designated by the center-of-gravity position information, the weight designated by the weight information, and the weight distribution designated by the weight distribution information are achieved.

For example, the higher the infill filling rate is, the larger the weight is. When the fill pattern is adjusted, the infill filling rate can be changed. When the line width is adjusted, the weight can be changed. When the depositing pitch is adjusted, the weight can be changed. For example, by using metal injection molding (MIM) including a metal filler as the modeling material, as compared with a case where the modeling material is made of a resin not including the metal filler, a weight is increased.

The information processing apparatus 60 May adjust the model data generation conditions for each layer L. In one layer L, the information processing apparatus 60 may concentrically change the model data generation conditions, may change the model data generation conditions with gradation for each region A, or may continuously change the model data generation conditions with the gradation.

The information processing apparatus 60 May adjust the condition of the infill filling rate, the condition of the fill pattern, the condition of the line width, the condition of the depositing pitch, and the condition of the modeling material with a priority order. For example, the information processing apparatus 60 May first adjust conditions of the infill filling rate and the fill pattern, and when the center-of-gravity position designated by the center-of-gravity position information is not obtained even if the condition is adjusted, the information processing apparatus 60 may adjust the condition of the line width. Further, when the center-of-gravity position designated by the center-of-gravity position information is not obtained even if the condition of the line width is adjusted, the information processing apparatus 60 may sequentially adjust the condition of the depositing pitch and the condition of the modeling material. The priority order of the conditions may be designated by the user.

### 1.2.6. Step S6

Next, as shown in FIG. 4, the information processing apparatus 60 performs processing of generating the model data based on the acquired designation information. Specifically, the information processing apparatus 60 generates the model data based on the model data generation conditions determined based on the designation information.

The model data includes information on a relative path of the extruding unit 10 with respect to the stage 20, and information on an extruding amount of the modeling material from the extruding unit 10 in the path. The model data is represented by, for example, a G code or an M code.

Here, FIG. 8 is a diagram showing the model data. Specifically, FIG. 8 is a diagram showing the model data for forming the internal path P_{IN} shown in FIG. 7. In the example shown in FIG. 8, information on a path included in the model data is shown as coordinates (X, Y, Z). Information on the extruding amount included in the model data is shown as “E”.

A command COM1 of the model data moves the extruding unit 10 to a position (X1, Y1, Z1) with respect to the stage 20. The position (X1, Y1, Z1) corresponds to a start point F1 of the internal path P_{IN} shown in FIG. 7. The command COM1 shows “E1”, and does not cause the modeling material to be extruded during the movement.

A command COM2 of the model data moves the extruding unit 10 from the position (X1, Y1, Z1) to (X1, Y2, Z1) with respect to the stage 20. The command COM2 shows “E2”, and causes the extruding unit 10 to extrude a predetermined amount of the modeling material during the movement. Accordingly, a first path P1 of the internal path P_{IN} shown in FIG. 7 is formed.

A command COM3 of the model data moves the extruding unit 10 from the position (X1, Y2, Z1) to (X2, Y2, Z1) with respect to the stage 20. The command COM3 extrudes a predetermined amount of the modeling material from the extruding unit 10 during the movement. Accordingly, a second path P2 of the internal path P_{IN} is formed.

A command COM4 of the model data moves the extruding unit 10 from the position (X2, Y2, Z1) to (X2, Y1, Z1) with respect to the stage 20. The command COM4 extrudes a predetermined amount of the modeling material from the extruding unit 10 during the movement. Accordingly, a third path P3 of the internal path P_{IN} is formed.

A command COM5 of the model data moves the extruding unit 10 from the position (X2, Y1, Z1) to (X3, Y1, Z1) with respect to the stage 20. The command COM5 extrudes a predetermined amount of the modeling material from the extruding unit 10 during the movement. Accordingly, a fourth path P4 of the internal path P_{IN} is formed.

As described above, the model data includes a plurality of commands corresponding to a plurality of paths of the internal path P_{IN}. For example, in order to form the internal path P_{IN} shown in FIG. 7, the model data includes the commands COM1 to COM21 as shown in FIG. 8. A position (X11, Y2, Z1) of the command COM21 corresponds to an end point F2 of the internal path P_{IN} shown in FIG. 7.

Although not illustrated, when a value of “Z” is changed, the model data can form paths in other layers L. Further, for example, when a value of “E” is changed, the model data can change the extruding amount of the modeling material. Further, the model data includes a command for forming the outer periphery path P_{OUT}. Further, the model data may include information corresponding to a speed of the extruding unit 10 with respect to the stage 20.

### 1.2.7. Step S7

Next, as shown in FIG. 4, the information processing apparatus 60 performs processing of calculating the center-of-gravity position and the weight of the three-dimensional object based on the model data. When the center-of-gravity position information is included in the designation information but the weight information is not included in the designation information, the information processing apparatus 60 may calculate the center-of-gravity position but not calculate the weight. Further, when the weight information is included in the designation information but the center-of-gravity position information is not included in the designation information, the information processing apparatus 60 may calculate the weight but not calculate the center-of-gravity position.

### 1.2.8. Step S8

Next, the information processing apparatus 60 performs processing of displaying the value calculated in step S7 on the display unit 52. The information processing apparatus 60 displays, for example, the calculated center-of-gravity position and the calculated weight on the display unit 52.

### 1.2.9. Step S9

Next, the information processing apparatus 60 performs processing of determining whether the calculated value and the value designated in the designation information deviate from each other by a predetermined value or more. The predetermined value that is a reference for the determination is designated by, for example, the user.

When it is determined that the calculated value and the designated value deviate from each other by the predetermined value or more (“YES” in step S9 in FIG. 4), the information processing apparatus 60 returns the processing to step S5. Until it is determined that the calculated value and the designated value do not deviate from each other by the predetermined value or more, the information processing apparatus 60 repeats steps S5 to S9. The information processing apparatus 60 may perform steps S5 to S9 again by correcting the model data generated once, or may perform steps S5 to S9 again by generating new model data based on the acquired designation information.

The information processing apparatus 60 may perform steps S5 to S10 again based on correction instruction information transmitted by an operation of the reception unit 50 performed by the user. The correction instruction information includes, for example, the corrected weight distribution information. The user may confirm a result displayed on the display unit 52 in step S8 to correct the weight distribution information, and may transmit the corrected weight distribution information to the information processing apparatus 60 by the operation of the reception unit 50.

The information processing apparatus 60 May automatically determine the model data generation conditions such that a difference between the calculated value and the designated value is small without acquiring the correction instruction information, and perform steps S5 to S9 again.

On the other hand, when it is determined that the calculated value and the designated value do not deviate from each other by the predetermined value or more (“NO” in step S9 in FIG. 4), the information processing apparatus 60 ends the processing.

### 1.3. Processing of Control Unit

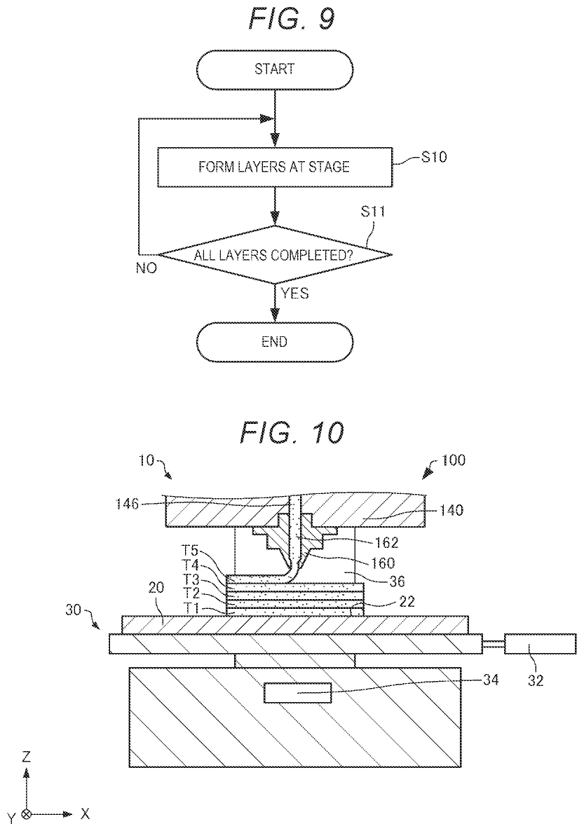

Next, processing of the control unit 40 will be described with reference to the drawings. FIG. 9 is a flowchart showing the processing of the control unit 40. When the information processing apparatus 60 ends the processing, the control unit 40 starts the processing.

### 1.3.1. Step S10

As shown in FIG. 9, the control unit 40 performs processing of controlling the extruding unit 10 and the movement unit 30 based on the generated model data and forming layers constituting the three-dimensional object on the deposition surface 22 of the stage 20.

Specifically, the control unit 40 plasticizes the material supplied between the flat screw 130 and the barrel 140 to generate the modeling material, and extrudes the modeling material from the nozzle 160 of the extruding unit 10. The control unit 40 continues to generate the modeling material until, for example, the processing in step S10 is ended.

Here, FIG. 10 is a cross-sectional view showing processing of the control unit 40 in step S10. As shown in FIG. 10, the control unit 40 controls the extruding unit 10 and extrudes the modeling material from the nozzle 160 toward the stage 20 while controlling the movement unit 30 to change the relative position between the extruding unit 10 and the stage 20 based on the model data.

Specifically, before the processing in step S10 is started, that is, before formation of a first layer T1 is started, the nozzle 160 is disposed at an initial position in the -X-axis direction with respect to an end portion of the stage 20 in the -X-axis direction. When the processing in step S10 is started, the control unit 40 controls the movement unit 30, thereby, for example, relatively moving the nozzle 160 in the +X-axis direction with respect to the stage 20. When the nozzle 160 passes over the stage 20, the modeling material is extruded from the nozzle 160. Accordingly, the layer T1 is formed. FIG. 10 illustrates up to a fifth layer T5.

### 1.3.2. Step S11

Next, as shown in FIG. 9, the control unit 40 performs determination processing of determining whether formation of all layers is completed based on the model data.

When it is determined that the formation of all the layers is not completed (“NO” in step S11 in FIG. 9), the control unit 40 returns the processing to step S10. The control unit 40 repeats steps S10 and S11 until it is determined in step S11 that the formation of all the layers is completed.

On the other hand, when it is determined that the formation of all the layers is completed (“YES” in step S11 in FIG. 9), the control unit 40 ends the processing.

As described above, it is possible to fabricate the three-dimensional object including the plurality of deposited layers. As described above, a manufacturing method of the three-dimensional object according to the embodiment is performed using the information processing apparatus 60 and the three-dimensional fabrication device 100.

### 1.4. Functions and Effects

The information processing apparatus 60 includes: the acquisition unit 62 that acquires the designation information including at least one of the information for designating the center-of-gravity position of the three-dimensional object and the information for designating the weight of the three-dimensional object; and the data generation unit 64 that generates the model data including the information on the path of the extruding unit 10 with respect to the stage 20 and the information on the extruding amount of the modeling material in the path based on the designation information. The control unit 40 performs the processing of controlling the extruding unit 10 based on the model data and fabricating the three-dimensional object. Therefore, in the manufacturing method of the three-dimensional object using the information processing apparatus 60, at least one of the center-of-gravity position and the weight of the three-dimensional object can be brought close to a desired one. Accordingly, convenience of the user can be improved.

The designation information acquired by the information processing apparatus 60 includes the information for designating the weight distribution of the three-dimensional object. Therefore, in the manufacturing method of the three-dimensional object using the information processing apparatus 60, the weight distribution of the three-dimensional object can be brought close to a desired one.

The information processing apparatus 60 performs the processing of calculating at least one of the center-of-gravity position and the weight of the three-dimensional object based on the model data, and correcting the model data or generating new model data when the calculated value and the value designated in the designation information deviate from each other by the predetermined value or more. Therefore, in the manufacturing method of the three-dimensional object using the information processing apparatus 60, at least one of the center-of-gravity position and the weight of the three-dimensional object can be brought closer to a desired one.

The information processing apparatus 60 performs the processing of calculating at least one of the center-of-gravity position and the weight of the three-dimensional object based on the model data, and displaying the calculated value on the display unit 52. Therefore, the user can recognize the calculated value.

The information processing apparatus 60 performs the processing of adjusting at least one of the condition of the infill filling rate, the condition of the fill pattern, the condition of the line width, the condition of the depositing pitch, and the condition of the modeling material to determine the model data generation conditions based on the designation information, and generates the model data based on the determined model data generation conditions in the processing of generating the model data. Therefore, in the manufacturing method of the three-dimensional object using the information processing apparatus 60, it is possible to generate the model data in consideration of at least one of the condition of the infill filling rate, the condition of the fill pattern, the condition of the line width, the condition of the depositing pitch, and the condition of the modeling material.

### 2. Modification of Processing of Information Processing Apparatus

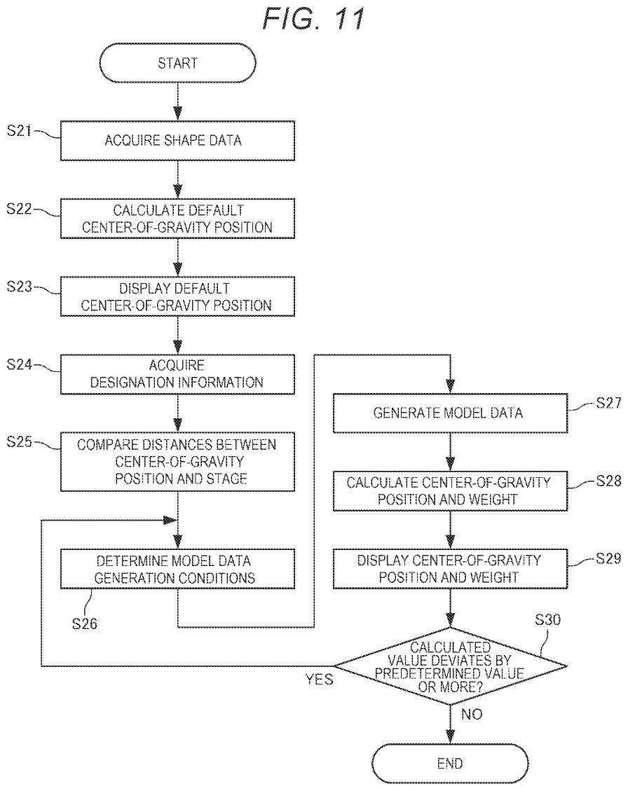

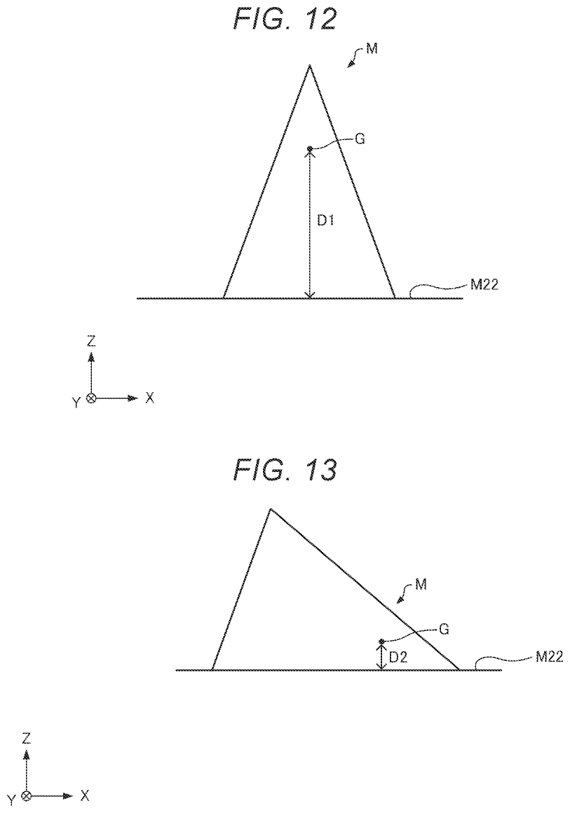

Next, a modification of the processing of the information processing apparatus 60 will be described with reference to the drawings. FIG. 11 is a flowchart showing the modification of the processing of the information processing apparatus 60. FIGS. 12 to 14 are diagrams showing the model M formed in the modification of the processing of the information processing apparatus 60.

Steps S21 to S24 shown in FIG. 11 are basically the same as steps S1 to S4 shown in FIG. 4 described above.

As shown in FIG. 11, as step S25, the information processing apparatus 60 performs processing of comparing a distance between the center-of-gravity position designated by the designation information and the stage 20 when the three-dimensional object is disposed in a first orientation and when the three-dimensional object is disposed in a second orientation different from the first orientation at the stage 20 based on acquired shape data.

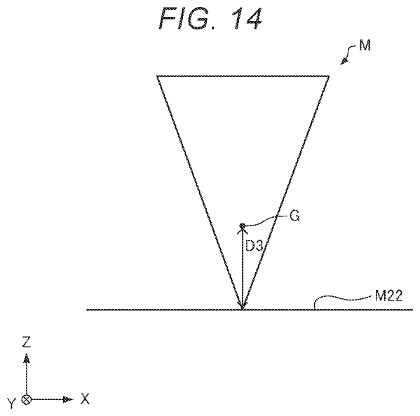

Specifically, the information processing apparatus 60 compares a distance between a center-of-gravity position G designated by the designation information and a stage surface M22 when the model M of the three-dimensional object is disposed in the first orientation shown in FIG. 12, the distance when the model M of the three-dimensional object is disposed in the second orientation shown in FIG. 13, and the distance when the model M of the three-dimensional object is disposed in a third orientation shown in FIG. 14 at the stage surface M22 corresponding to the deposition surface 22 of the stage 20 based on the acquired shape data.

In the example shown in FIGS. 12 to 14, the model M is a square pyramid. In the example shown in FIG. 12, a bottom surface of the square pyramid is in contact with the stage surface M22. In the example shown in FIG. 13, a side surface of the square pyramid is in contact with the stage surface M22. In the example shown in FIG. 14, a vertex of the square pyramid is in contact with the stage surface M22. A distance D2 between the center-of-gravity position G and the stage surface M22 shown in FIG. 13 is smaller than a distance D1 between the center-of-gravity position G and the stage surface M22 shown in FIG. 12 and a distance D3 between the center-of-gravity position G and the stage surface M22 shown in FIG. 14.

Next, as shown in FIG. 11, the information processing apparatus 60 determines the model data generation conditions for the orientation of the three-dimensional object whose distance compared in step S25 is smallest as step S26. In the above-described case, the model data generation conditions for the orientation of the model M shown in FIG. 13 are determined. The information processing apparatus 60 generates model data for the orientation of the three-dimensional object whose distance compared in step S25 is smallest as step S27. Processings in other steps S26 and S27 are basically the same as steps S5 and S6 in FIG. 4 described above.

Next, as shown in FIG. 11, the information processing apparatus 60 performs processings in steps S28 to S30. Steps S28 to S30 are basically the same as steps S7 to S9 shown in FIG. 4 described above.

For example, when a posture of the three-dimensional object is unstable as shown in FIG. 14, the information processing apparatus 60 may control the extruding unit 10 and the movement unit 30 to dispose a support material (not shown). The support material is a member that supports the three-dimensional object such that the three-dimensional object does not fall down. The support material is extruded from, for example, the extruding unit 10.

The information processing apparatus 60 performs processing of comparing the distance between the center-of-gravity position designated by the designation information and the stage 20 when the three-dimensional object is disposed in the first orientation and the distance when the three-dimensional object is disposed in the second orientation different from the first orientation at the stage 20, and generates the model data for the orientation of the three-dimensional object whose distance is smaller in the processing of generating the model data. Therefore, in the manufacturing method of the three-dimensional object using the information processing apparatus 60, it is possible to reduce a possibility that a portion below the center-of-gravity position of the three-dimensional object collapses. For example, when the distance between the center-of-gravity position of the three-dimensional object and the stage is large, the portion below the center-of-gravity position is likely to collapse due to a weight near the center-of-gravity position.

### 3. Material Stored in Three-Dimensional Shaping Apparatus

The material stored in the material storing unit 110 described above is an ABS resin, but is not limited thereto.

Examples of the material stored in the material storing unit 110 can include a material using various materials such as a thermoplastic material, a metal material, and a ceramic material as main materials. Here, the term “main material” means a material serving as a center that forms a shape of an object fabricated by the three-dimensional fabrication device, and means a material that accounts for a content of 50 mass% or more in the object. The material described above includes that obtained by melting the main materials alone, or that obtained by melting certain components contained together with the main materials into a paste.

As the thermoplastic material, for example, a thermoplastic resin can be used. Examples of the thermoplastic resin include general-purpose engineering plastic and super engineering plastic.

Examples of the general-purpose engineering plastic include polypropylene (pp), polyethylene (PE), polyacetal (POM), polyvinyl chloride (PVC), polyamide (PA), polylactic acid (PLA), polyphenylene sulfide (PPS), polycarbonate (PC), modified polyphenylene ether, polybutylene terephthalate, and polyethylene terephthalate.

Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyetheretherketone (PEEK).

The thermoplastic material may be mixed with a pigment, a metal, a ceramic, and an additive such as wax, a flame retardant, an antioxidant, and a heat stabilizer. The thermoplastic material is converted into a state of being plasticized and melted by the rotation of the flat screw 130 and the heating of the heater 150 in the plasticization unit 120. Further, the modeling material generated as described above is cured due to a decrease in temperature after being deposited from the nozzle 160. It is desirable that the thermoplastic material be extruded from the nozzle 160 in a state of being heated to a temperature equal to or higher than the glass transition point and being completely melted.

In the plasticization unit 120, for example, a metal material may be used as a main material instead of using the thermoplastic material described above. In this case, it is desirable that a component to be melted when generating the modeling material be mixed with a powder material obtained by making a metal material in a powder state, and that a mixture be put into the plasticization unit 120.

Examples of the metal material include a single metal including magnesium (Mg), iron (Fe), cobalt (Co), chromium (Cr), aluminum (Al), titanium (Ti), copper (Cu), and nickel (Ni), or an alloy containing one or more of the metals, maraging steel, stainless steel, cobalt-chromium-molybdenum, a titanium alloy, a nickel alloy, an aluminum alloy, a cobalt alloy, and a cobalt-chromium alloy.

In the plasticization unit 120, a ceramic material can be used as a main material instead of using the metal material described above. Examples of the ceramic material include an oxide ceramic such as silicon dioxide, titanium dioxide, aluminum oxide, and zirconium oxide, and a non-oxide ceramic such as aluminum nitride.

The powder material of the metal material or the ceramic material stored in the material storing unit 110 may be a mixed material obtained by mixing a plurality of types of powder including single metal powder, alloy powder, and ceramic material powder. Further, the powder material of the metal material or the ceramic material may be coated by, for example, the thermoplastic resin described above or another thermoplastic resin. In this case, in the plasticization unit 120, the thermoplastic resin may be melted to exhibit fluidity.

For example, a solvent can be added to the powder material of the metal material or the ceramic material stored in the material storing unit 110. Examples of the solvent include water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide solvents such as dimethyl sulfoxide, and diethyl sulfoxide; pyridine-based solvents such as pyridine, γ-picoline, and 2,6-lutidine; tetraalkylammonium acetate (for example, tetrabutylammonium acetate); and ionic liquid such as butyl carbitol acetate.

In addition, for example, a binder may be added to the powder material of the metal material or the ceramic material stored in the material storing unit 110. Examples of the binder include an acrylic resin, an epoxy resin, a silicone resin, a cellulose-based resin, other synthetic resins, PLA, PA, PPS, PEEK, and other thermoplastic resins.

The embodiment and the modification described above are merely examples, and the present disclosure is not limited thereto. For example, each embodiment and each modification can be appropriately combined.

The present disclosure includes configurations substantially the same as the configuration described in the embodiment, for example, configurations having the same function, method, and result, or configurations having the same object and effects. Further, the present disclosure includes a configuration in which an unnecessary portion of the configuration described in the embodiment is replaced. Further, the present disclosure includes a configuration having functions and effects the same as those of the configuration described in the embodiment, or a configuration that can achieve the same object. Further, the present disclosure includes a configuration obtained by adding a known technique to the configuration described in the embodiment.

The following contents are derived from the embodiment and the modification described above.

One aspect of a manufacturing method of a three-dimensional object is a manufacturing method of a three-dimensional object for manufacturing the three-dimensional object by extruding a modeling material from an extruding unit toward a stage and depositing layers, the manufacturing method including:
acquiring designation information including at least one of information for designating a center-of-gravity position of the three-dimensional object and information for designating a weight of the three-dimensional object;
generating model data including information on a path of the extruding unit with respect to the stage and information on an extruding amount of the modeling material in the path based on the designation information; and
controlling the extruding unit based on the model data and fabricating the three-dimensional object.

According to the manufacturing method of a three-dimensional object, at least one of the center-of-gravity position and the weight of the three-dimensional object can be brought close to a desired one.

In the manufacturing method of the three-dimensional object according to one aspect,
the designation information may include information for designating a weight distribution of the three-dimensional object.

According to the manufacturing method of the three-dimensional object, the weight distribution of the three-dimensional object can be brought close to a desired one.

The manufacturing method of the three-dimensional object according to one aspect may further include:
calculating at least one of the center-of-gravity position and the weight of the three-dimensional object based on the model data, and correcting the model data or generating new model data when a calculated value and a value designated in the designation information deviate from each other by a predetermined value or more.

According to the manufacturing method of the three-dimensional object, at least one of the center-of-gravity position and the weight of the three-dimensional object can be brought closer to a desired one.

The manufacturing method of the three-dimensional object according to one aspect may further include:
calculating at least one of the center-of-gravity position and the weight of the three-dimensional object based on the model data, and displaying a calculated value on a display unit.

According to the manufacturing method of the three-dimensional object, the user can recognize the calculated value.

The manufacturing method of the three-dimensional object according to one aspect may further include:
comparing a distance between the center-of-gravity position designated by the designation information and the stage when the three-dimensional object is disposed in a first orientation relative to the stage and the distance when the three-dimensional object is disposed in a second orientation different from the first orientation relative to the stage, in which
the model data in one of the orientations in which the distance is smaller may be generated in generating the model data.

According to the manufacturing method of the three-dimensional object, it is possible to reduce a possibility that a portion below the center-of-gravity position of the three-dimensional object collapses.

The manufacturing method of the three-dimensional object according to one aspect may further include:
adjusting at least one of a condition of an infill filling rate, a condition of a fill pattern, a condition of a line width, a condition of a depositing pitch, and a condition of the modeling material based on the designation information and determining a model data generation condition, in which
the model data may be generated based on the model data generation condition in generating the model data.

According to the manufacturing method of the three-dimensional object, it is possible to generate the model data in consideration of at least one of the condition of the infill filling rate, the condition of the fill pattern, the condition of the line width, the condition of the depositing pitch, and the condition of the modeling material.

One aspect of an information processing apparatus is an information processing apparatus for generating model data for manufacturing a three-dimensional object by extruding a modeling material from an extruding unit toward a stage and depositing layers, the information processing apparatus including:
an acquisition unit configured to acquire designation information including at least one of information for designating a center-of-gravity position of the three-dimensional object and information for designating a weight of the three-dimensional object; and
a data generation unit configured to generate the model data including information on a path of the extruding unit with respect to the stage and information on an extruding amount of the modeling material in the path based on the designation information.

According to the information processing apparatus, at least one of the center-of-gravity position and the weight of the three-dimensional object can be brought close to a desired one.

What is claimed is:

1. A manufacturing method of a three-dimensional object for manufacturing the three-dimensional object by extruding a modeling material from an extruding unit toward a stage and depositing layers, the manufacturing method comprising:
acquiring designation information including at least one of information for designating a center-of-gravity position of the three-dimensional object and information for designating a weight of the three-dimensional object;
generating model data including information on a path of the extruding unit with respect to the stage and information on an extruding amount of the modeling material in the path based on the designation information; and
controlling the extruding unit based on the model data and fabricating the three-dimensional object.

2. The manufacturing method of the three-dimensional object according to claim 1, wherein the designation information includes information for designating a weight distribution of the three-dimensional object.

3. The manufacturing method of the three-dimensional object according to claim 1, further comprising:
calculating at least one of the center-of-gravity position and the weight of the three-dimensional object based on the model data, and correcting the model data or generating new model data when a calculated value and a value designated in the designation information deviate from each other by a predetermined value or more.

4. The manufacturing method of the three-dimensional object according to claim 1, further comprising:
calculating at least one of the center-of-gravity position and the weight of the three-dimensional object based on the model data, and displaying a calculated value on a display unit.

5. The manufacturing method of the three-dimensional object according to claim 1, further comprising:
comparing a distance between the center-of-gravity position designated by the designation information and the stage when the three-dimensional object is disposed in a first orientation relative to the stage and the distance when the three-dimensional object is disposed in a second orientation different from the first orientation relative to the stage, wherein
the model data in one of the orientations in which the distance is smaller is generated in generating the model data.

6. The manufacturing method of the three-dimensional object according to claim 1, further comprising:
adjusting at least one of a condition of an infill filling rate, a condition of a fill pattern, a condition of a line width, a condition of a depositing pitch, and a condition of the modeling material based on the designation information and determining a model data generation condition, wherein
the model data is generated based on the model data generation condition in generating the model data.
